(19) United States
(12) Patent Application Publication
(10) Pub. No.: US 2009/0201283 A1
(43) Pub. Date: Aug. 13, 2009

(54) SOURCE DRIVER OF LCD PANEL

(75) Inventors: Hiroyuki Inokuchi, Kyoto-Ku (JP); Takatoshi Uchida, Ukyo-Ku (JP); Yusuke Mizuno, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/262,898

(22) Filed: Oct. 31, 2008

(30) Foreign Application Priority Data
Oct. 31, 2007 (JP) JP2007-283936

(51) Int. Cl. G06F 3/038; G09G 3/36

(52) U.S. Cl. 345/212; 345/87

(57) ABSTRACT

A source driver performs inversion driving of data lines of a liquid crystal panel. For every two adjacent data lines, there are provided a high-side amplifier HAMP which generates a driving voltage of a first polarity and a low-side amplifier LAMP which generates a driving voltage of a second polarity opposite to the first polarity. Further, an output switch SW outputs to the two data lines LD by switching between the two driving voltages Vp, Vn that have been generated by the high-side amplifier HAMP and the low-side amplifier LAMP. The power supply terminal on the low-potential side of the high-side amplifier HAMP and the power supply terminal on the high-potential side of the low-side amplifier LAMP are connected to a common charge share capacitor C1.

### BACKGROUND OF THE INVENTION

1. Field of the Invention

The present invention relates to a technique of driving a liquid crystal panel, and more particularly to a source driver which performs inversion driving of data lines.

2. Description of the Related Art

A liquid crystal panel includes a plurality of data lines, a plurality of scanning lines that are arranged to cross perpendicularly to the data lines, and a plurality of TFTs (Thin Film Transistors) that are arranged in a matrix form at the intersections of the data lines and the scanning lines. In order to drive the liquid crystal panel, there are provided a gate driver circuit that sequentially selects from the plurality of scanning lines and a source driver that applies to each data line a voltage that accords to brightness.

There is a problem in that, when a direct-current voltage is continuously applied to the data lines, the liquid crystal panel will be deteriorated. In order to solve this problem, in recent years, a method of alternately applying voltages having different polarities in an AC (alternating current) manner to each data line (an inverse driving method) is a main-stream idea.

[Patent Document 1] Japanese Patent Application (Laid Open) No. H8-320674.

In the case of performing inverse driving of the liquid crystal panel, first, a driving voltage of a first polarity is applied to one data line. At this time, the parasitic capacitance of the data line is charged. Then, a driving voltage of a second polarity having a level symmetric to the first polarity relative to a predetermined standard electric potential is applied to the data line. At this time, the electric charge stored in the parasitic capacitance of the data line is discharged. The discharging current at this time flows to the ground as a discarded electric current. Namely, there is a problem in that an electric power consumption will increase when the liquid crystal panel is subjected to inverse driving. In addition, heat generation accompanying the increase in the electric power consumption will also be a problem.

### SUMMARY OF THE INVENTION

The present invention has been made in view of the above-mentioned circumstances, and a general purpose thereof is to provide a source driver of a liquid crystal panel with reduced electric power consumption.

One embodiment of the present invention relates to a source driver which performs inversion driving of a plurality of data lines of a liquid crystal panel. For every two adjacent data lines, this source driver includes a high-side amplifier which generates a driving voltage of a first polarity, a low-side amplifier which generates a driving voltage of a second polarity opposite to the first polarity, and an output switch which outputs to the two data lines by switching between two driving voltages that have been generated by the high-side amplifier and the low-side amplifier. A power supply terminal on a low-potential side of the high-side amplifier and a power supply terminal on a high-potential side of the low-side amplifier are connected to a common charge share capacitor.

The first polarity refers to a voltage level that is higher than a predetermined standard electric potential, and the second polarity refers to a voltage level that is lower than the standard electric potential.

According to this embodiment, a part of the conventionally discarded current can be transferred to the charge share capacitor and re-utilized, so that the electric power consumption can be reduced.

A plurality of high-side amplifiers and a plurality of low-side amplifiers may be divided into segments, and a common charge share capacitor may be connected to the high-side amplifiers and the low-side amplifiers that are included in an identical segment. The segment may be formed by grouping some adjacent high-side amplifiers and low-side amplifiers as a unit, or using the color of the driven pixels as a unit.

A source driver according to one embodiment may further include a regulator which stabilizes a voltage of the charge share capacitor to a predetermined potential. By disposing the regulator, the power supply voltages of the high-side amplifier and the low-side amplifier can be stabilized even if the driving voltage supplied to the data lines undergoes large variation.

The regulator may stabilize the voltage of the charge share capacitor using a midpoint voltage of a power supply voltage on a high-potential side of the high-side amplifier and a power supply voltage on a low-potential side of the low-side amplifier as a target value.

A source driver according to one embodiment may further include a charge share switch disposed between each data line and the charge share capacitor.

In this case, by turning the charge share switch on, the electric charge on the data line can be transferred to the charge share capacitor.

A source driver according to one embodiment repeats setting the output switch so as to drive one data line with the high-side amplifier and to drive the other data line with the low-side amplifier, bringing the output switch to an off-state and turning the charge share switch on, setting the output switch so as to drive the other data line with the high-side amplifier and to drive the one data line with the low-side amplifier, and bringing the output switch to an off-state and turning the charge share switch on.

Another embodiment of the present invention is a liquid crystal display device. This device includes a liquid crystal panel, any one of the above-described source drivers which drives the data lines of the liquid crystal panel, and a gate driver circuit which drives the scanning lines of the liquid crystal panel.

According to this embodiment, the electric power consumption of a liquid crystal display can be reduced, and the amount of generated heat can be reduced.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating a construction of a liquid crystal display provided with a source driver according to an embodiment of the present invention;

FIGS. 2A to 2D are circuit diagrams illustrating a state transition of the source driver of FIG. 1; and

FIG. 3 is an operation waveform diagram of the source driver of FIG. 1.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “the state in which a member A is connected to a member B” includes a case in which the member A and the member B are directly physically connected and a case in which the member A and the member B are indirectly connected via another member that does not affect the electric connection state. Similarly, “the state in which a member C is disposed between a member A and a member B” includes a case in which the member A and the member C or the member B and the member C are directly connected and a state in which they are indirectly connected via another member that does not affect the electric connection state.

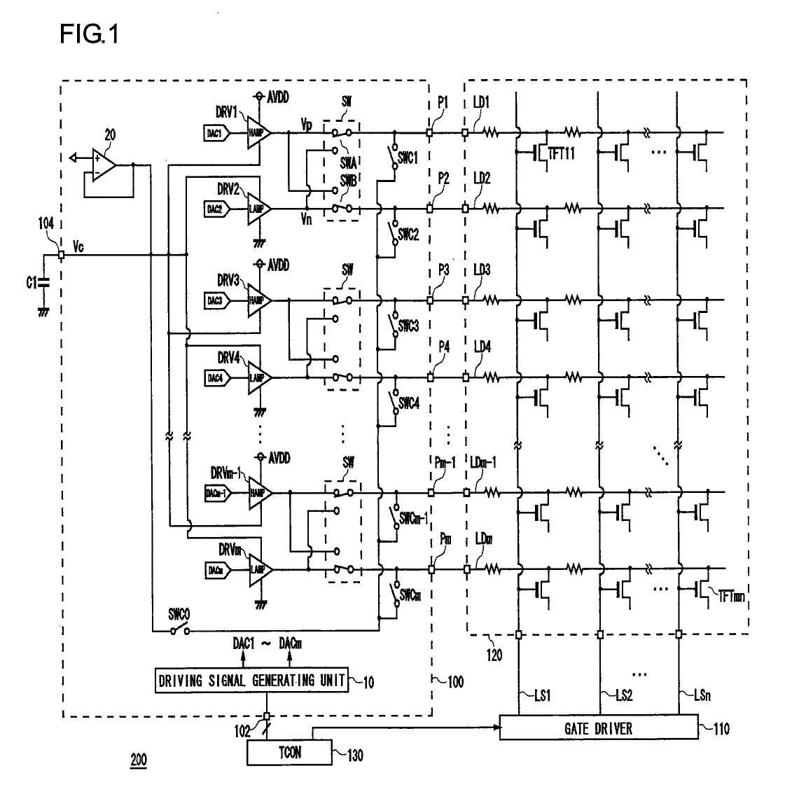

FIG. 1 is a circuit diagram illustrating a construction of a liquid crystal display 200 provided with a source driver 100 according to an embodiment of the present invention.

The liquid crystal display 200 includes a source driver 100, a gate driver 110, a liquid crystal panel 120, and a timing controller 130.

The liquid crystal panel 120 is provided with m data lines LD and n scanning lines LS. Pixel circuits arranged in a matrix form are disposed at the intersections of the data lines LD and the scanning lines LS. FIG. 1 shows only a TFT for each pixel. The gate of the TFTij in the i-throw and in the j-th column is connected to the scanning line LSj of the j-th column, and the source thereof is connected to the data line LDi of the i-th row.

The gate driver 110 receives data from the timing controller 130, and makes a selection by giving a voltage sequentially to the plurality of scanning lines LS1 to LSn. The source driver 100 receives brightness data from the timing controller 130, and supplies to the plurality of data lines LD1 to LDm a driving voltage according to the brightness data. The source driver 100 performs inversion driving of alternately applying a driving voltage of a first polarity being higher than a predetermined standard voltage and a driving voltage of a second polarity being lower than the predetermined standard voltage to the data line LD.

The source driver 100 is a functional IC that is monolithically integrated on one semiconductor substrate. The output terminals P1 to Pm of the source driver 100 are respectively connected to the data lines LD1 to LDm (hereafter generally referred to as the data line LD). Also, the data input terminal 102 of the source driver 100 receives input of brightness data for each pixel. A later-mentioned charge share capacitor C1 for retaining electric charge is connected to the capacitor terminal 104.

Two adjacent data lines LD form a pair. Namely, the data lines LD1 and LD2 form a first pair, and the data lines LD3 and LD4 form a second pair. To generalize this, the data lines LD(2i-1) and LD(2i) form the i-th pair.

The source driver 100 is provided with a high-side amplifier HAMP, a low-side amplifier LAMP, and an output switch SW for every two data lines that form a pair.

In other words, to the i-th pair of the data lines LD, there are disposed a driver amplifier DRV(2i-1) which is a high-side amplifier HAMP, a driver amplifier DRV(2i) which is a low-side amplifier LAMP, and an output switch SW. The driver amplifier is constructed as a voltage follower circuit using an operation amplifier.

The high-side amplifier HAMP generates a driving voltage Vp of a first polarity. The low-side amplifier LAMP generates a driving voltage Vn of a second polarity opposite to the first polarity. The output switch SW outputs to the two data lines LD(2i-1) and LD(2i) by switching between the driving voltage Vp generated by the high-side amplifier HAMP and the driving voltage Vn generated by the low-side amplifier LAMP.

The output switch SW of FIG. 1 includes two switches SWA, SWB. In a straight connection state, the switch SWA selects the output voltage Vp of the high-side amplifier HAMP, and the switch SWB selects the output voltage Vn of the low-side amplifier LAMP. In a cross connection state, the switch SWA selects the output voltage Vn of the low-side amplifier LAMP, and the switch SWB selects the output voltage Vp of the high-side amplifier HAMP.

The driving signal generating unit 10 receives brightness data for each pixel via the data input terminal 102, and generates a signal to be supplied to each data line LD in a digital value. The digital value for each data line LD is output to digital analog converters DAC1 to DACm. The digital analog converters DAC1 to DACm convert the digital value into an analog voltage, and outputs it to corresponding driver amplifiers DRV1 to DRVm. The driver amplifier DRV generates driving voltages Vp, Vn according to the input analog voltages.

To the power supply terminal on the high-potential side of the high-side amplifier HAMP, a power supply voltage AVDD is supplied as a first fixed voltage. To the power supply terminal on the low-potential side of the low-side amplifier LAMP, a ground voltage GND is applied as a second fixed voltage. Here, to the power supply terminal on the low-potential side of the low-side amplifier LAMP, a negative power supply voltage −AVDD may be supplied as a second fixed voltage instead of the ground voltage. Alternatively, to the power supply terminal on the high-potential side of the high-side amplifier HAMP, a ground voltage GND may be supplied as a first fixed voltage instead of the power supply voltage AVDD and, to the power supply terminal on the low-potential side of the low-side amplifier LAMP, a negative power supply voltage −AVDD may be supplied as a second fixed voltage. Namely, the first fixed voltage and the second fixed voltage are arbitrary.

The power supply terminal on the low-potential side of the high-side amplifier HAMP and the power supply terminal on the high-potential side of the low-side amplifier LAMP are connected to a common charge share capacitor C1 via a capacitor terminal 104. Therefore, the voltage Vc (hereafter also referred to as the capacitor voltage) at one end of the charge share capacitor C1, namely at the capacitor terminal 104, is supplied as a power supply voltage on the lower side of the high-side amplifier HAMP, and is supplied as a power supply voltage on the upper side of the low-side amplifier LAMP.

The source driver 100 further includes a regulator 20 that stabilizes the voltage at one end of the charge share capacitor C1 to a predetermined electric potential. The regulator 20 preferably stabilizes the voltage of the charge share capacitor C1 using a midpoint voltage AVDD/2 of the power supply voltage AVDD on the high-potential side of the high-side amplifier HAMP and the power supply voltage GND on the low-potential side of the low-side amplifier LAMP as a target value. However, the voltage of the target value is not limited to AVDD/2, and it will be sufficient if the high-side amplifier HAMP and the low-side amplifier LAMP can generate the driving voltage to be supplied to the data line in the whole range. From another viewpoint, it is preferable to make the target voltage of the charge share capacitor C1 coincide with the standard voltage which is a boundary of the first polarity and the second polarity of the driving voltage.

The source driver 100 further includes charge share switches SWC1 to SWCm and SWC0 that are disposed between the respective data lines LD1 to LDn and the charge share capacitor C1.

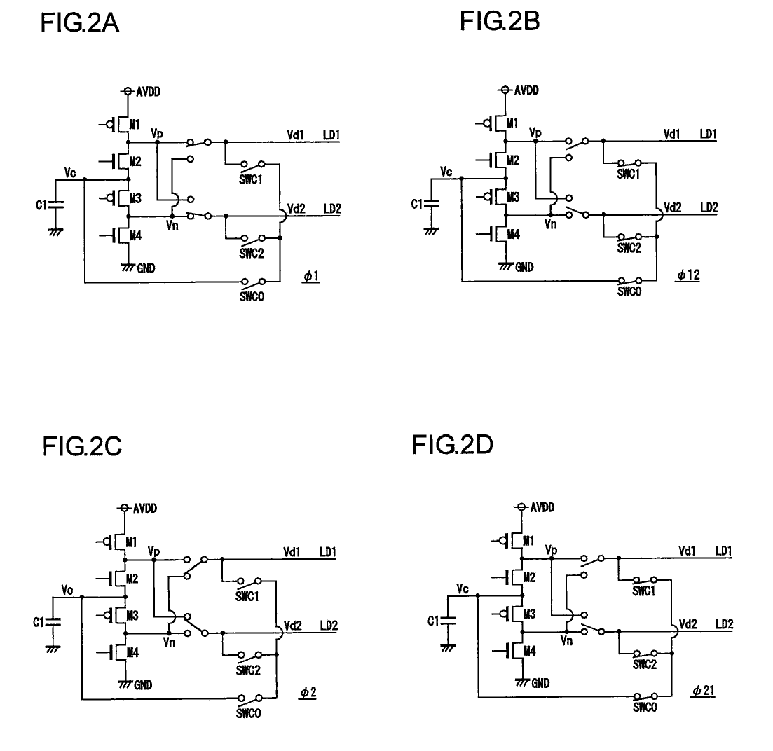

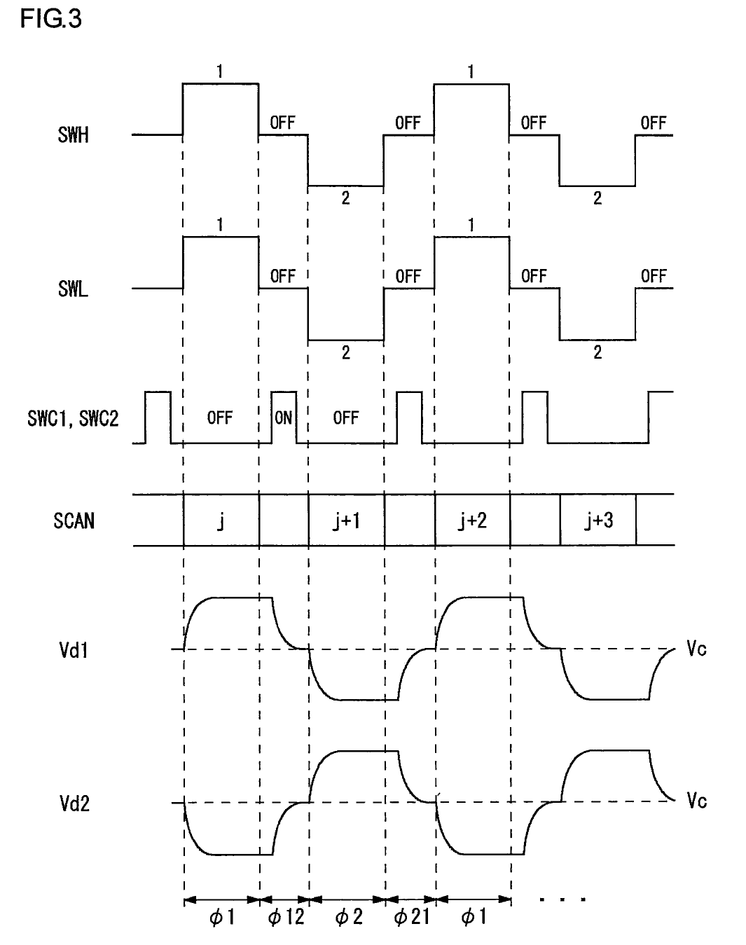

The above is the construction of the source driver 100. Subsequently, the operation of the source driver 100 will be described. FIGS. 2A to 2D are circuit diagrams illustrating a state transition of the source driver 100 of FIG. 1. FIG. 3 is an operation waveform diagram of the source driver 100 of FIG. 1.

FIGS. 2A to 2D show only the peripheral circuits of the two driver amplifiers DRV1, DRV2 that drive the two data lines LD1, LD2 forming a pair. Both of the high-side amplifier HAMP and the low-side amplifier LAMP include an output step of push-pull type. The high-side amplifier HAMP includes, as an output step, a P-channel MOSFET (hereafter referred to as the first transistor M1) and an N-channel MOSFET (hereafter referred to as the second transistor M2) that are connected in series between the power supply voltage AVDD and the capacitor voltage Vc. Also, the low-side amplifier LAMP includes, as an output step, a P-channel MOSFET (hereafter referred to as the third transistor M3) and an N-channel MOSFET (hereafter referred to as the fourth transistor M4) that are connected in series between the capacitor voltage Vc and the ground voltage GND. Illustration of the input differential step and the amplification step of the high-side amplifier HAMP and the low-side amplifier LAMP is omitted.

In synchronization with the selection operation of the scanning lines LS of the gate driver 110, the source driver 100 repeats the states of φ1, φ12, φ2, and φ21 described below.

φ1. When the gate driver 110 selects the j-th scanning line LSj, the source driver 100 drives the data line LD1 with the driving voltage Vp of the first polarity, and drives the data line LD2 with the driving voltage Vn of the second polarity. This state is referred to as the first state φ1. In the first state φ1, the output switch SW is set so that the one data line LD1 may be driven by the high-side amplifier HAMP and the other data line LD2 may be driven by the low-side amplifier LAMP. At this time, the charge share switches SWC1, SWC2, SWC0 are all set to be off. FIG. 2A shows an equivalent circuit of the first state φ1.

φ2. When the gate driver 110 selects the j+1-th scanning line LSj+1, the source driver 100 drives the data line LD1 with the driving voltage Vn of the second polarity, and drives the data line LD2 with the driving voltage Vp of the first polarity. This state is referred to as the second state φ2. In the second state φ2, the output switch SW is set so that the other data line LD2 may be driven by the high-side amplifier HAMP and the one data line LD1 may be driven by the low-side amplifier LAMP. At this time, the charge share switches SWC1, SWC2, SWC0 are all set to be off. FIG. 2C shows an equivalent circuit of the second state φ2.

In synchronization with the driving timing of the scanning lines LS by the gate driver 110, the source driver 100 alternately repeats the first state φ1 and the second state φ2. During the transition period from the first state φ1 to the second state φ2 and the transition period from the second state φ2 to the first state φ1, the following states are set.

φ12. At the timing of transition from the first state φ1 to the second state φ2, the source driver 100 is set in the first transition state φ12. In the first transition state φ12, the output switch SW will be in an off-state, whereby the high-side amplifier HMAP and the low-side amplifier LAMP are separated from the data lines LD1, LD2. At this time, the charge share switches SWC1, SWC2, and SWC0 are all set to be on. FIG. 2B shows an equivalent circuit of the first transition state φ12.

φ21. At the timing of transition from the second state φ2 to the first state φ1, the source driver 100 is set in the second transition state φ21. In the second transition state φ21, the output switch SW will be in an off-state, whereby the high-side amplifier HMAP and the low-side amplifier LAMP are separated from the data lines LD1, LD2. At this time, the charge share switches SWC1, SWC2, and SWC0 are all set to be on. FIG. 2D shows an equivalent circuit of the second transition state φ21. The circuit states of the first transition state φ12 and the second transition state φ21 are the same.

Thereafter, the state undergoes transition to the first state φ1, where the j+2-th scanning line LSj+2 is driven.

Namely, in synchronization with the driving timing of the scanning lines LS, the source driver 100 sequentially repeats the first state φ1, the first transition state φ12, the second state φ2, and the second transition state φ21.

Now, reference is made to the time chart of FIG. 3. In the first state φ1, the electric potential Vd1 of the data line LD1 rises with lapse of time, and is set to be the target voltage of the first polarity in accordance with the brightness. Also, the electric potential Vd2 of the data line LD2 lowers with lapse of time, and is set to be the target voltage of the second polarity in accordance with the brightness.

In the subsequent first transition state φ12, the charge share switches SWC1, SWC2, and SWC0 are turned on, whereby the data lines LD1, LD2 are connected to the charge share capacitor C1. As a result of this, the electric potentials Vd1, Vd2 of the data lines LD1, LD2 will coincide with the capacitor voltage Vc.

In the subsequent second state φ2, the electric potential Vd1 of the data line LD1 lowers with lapse of time, and is set to be the target voltage of the second polarity in accordance with the brightness. Also, the electric potential Vd2 of the data line LD2 rises with lapse of time, and is set to be the target voltage of the first polarity in accordance with the brightness.

In the subsequent second transition state φ21, the charge share switches SWC1, SWC2, and SWC0 are turned on, whereby the data lines LD1, LD2 are connected to the charge share capacitor C1. As a result of this, the electric potentials Vd1, Vd2 of the data lines LD1, LD2 will coincide with the capacitor voltage Vc.

With the source driver 100 according to the embodiment of the present invention, the sink current (suction current) of the high-side amplifier HAMP flows into the charge share capacitor C1 via the second transistor M2. Also, the source current (ejection current) of the low-side amplifier LAMP is supplied from the charge share capacitor C1 to the data lines via the third transistor M3. In other words, the electric charge supplied to the data lines by the high-side amplifier HAMP is collected into the charge share capacitor C1, and the electric charge can be used as a power source of the low-side amplifier LAMP.

As a result of this, the current that has been discarded to the ground every time the polarity of the driving voltage of each data line is switched as in the conventional case can be reduced. The source driver 100 according to the embodiment of the present invention can reduce the electric power consumption by almost 50% as compared with the conventional case. In accordance with the reduction of the electric power consumption, the heat generation of the circuits can be greatly reduced.

Also, in the embodiment, the high-side amplifier HAMP operates by receiving the power supply voltage AVDD and the capacitor voltage Vc, and the low-side amplifier LAMP operates by receiving the capacitor voltage Vc and the ground voltage GND. When it is set to satisfy Vc=AVDD/2, the operation voltage range of each amplifier will be AVDD/2.

In contrast, in a conventional source driver, both of the high-side amplifier and the low-side amplifier have been operated by giving the power supply voltage AVDD and the ground voltage GND without disposing the charge share capacitor C1. Namely, in the conventional case, the operation voltage range of each amplifier has been AVDD. Namely, with the source driver 100 according to the present embodiment, the voltage applied to each amplifier is reduced as compared with the conventional source driver, so that the electric power consumption can be reduced. Also, since a low breakdown voltage process can be used, the circuit area can be reduced as well.

Also, by disposing the regulator 20 that stabilizes the capacitor voltage Vc, the operation of the high-side amplifier HAMP and the low-side amplifier LAMP can be stabilized.

Further, by disposing the charge share switch SWC, the electric potential of the data line LD can be set to be the target value of the regulator 20 before it undergoes transition to the voltage corresponding to the brightness. The target value of the regulator 20 preferably coincides with the voltage corresponding to the zero brightness.

It will be understood by those skilled in the art that the embodiment is merely an exemplification, that various modifications can be made on the combinations of these constituent elements and the treatment processes, and that those modifications are also within the scope of the present invention.

In the embodiment, a case has been described in which a common charge share capacitor C1 is disposed for all of the driver amplifiers DRV1 to DRVm; however, the driver amplifiers may be divided into segments, and the charge share capacitor C1 may be disposed for each segment. By forming into segments, the capacitance per one charge share capacitor C1 can be reduced, and the CR time constant can be made small, so that the circuit operation can be carried out at a higher speed.

The segment may include some adjacent driver amplifiers as a unit. Since the brightnesses of adjacent pixels are stochastically close to each other in many cases, a high speed operation can be expected by forming these into a segment. Further, in this case, it will be advantageous in view of the layout of the circuits. Alternatively, the segment may be formed using the color of the pixels as a unit.

In the embodiment, a case has been described in which the charge share capacitor C1 is attached to the outside of the source driver 100; however, this maybe incorporated into the source driver 100.

While the preferred embodiments of the present invention have been described using specific terms, such description is for illustrative purposes only, and it is to be understood that changes and variations may be made without departing from the spirit or scope of the appended claims.

What is claimed is:

1. A source driver which performs inversion driving of a plurality of data lines of a liquid crystal panel, the source driver comprising, for every two adjacent data lines:
a high-side amplifier which generates a driving voltage of a first polarity;
a low-side amplifier which generates a driving voltage of a second polarity opposite to the first polarity; and
an output switch which outputs to the two data lines by switching between two driving voltages that have been generated by the high-side amplifier and the low-side amplifier,
wherein
a power supply terminal on a low-potential side of the high-side amplifier and a power supply terminal on a high-potential side of the low-side amplifier are connected to a common charge share capacitor.

2. The source driver according to claim 1, further comprising a regulator which stabilizes a voltage of the charge share capacitor to a predetermined potential.

3. The source driver according to claim 2,wherein
the regulator stabilizes the voltage of the charge share capacitor using a midpoint voltage of a power supply voltage on a high-potential side of the high-side amplifier and a power supply voltage on a low-potential side of the low-side amplifier as a target value.

4. The source driver according to claim 1, wherein
a plurality of high-side amplifiers and a plurality of low-side amplifiers are divided into segments, and a common charge share capacitor is connected to the high-side amplifiers and the low-side amplifiers that are included in an identical segment.

5. The source driver according to claim 1, further comprising a charge share switch disposed between each data line and the charge share capacitor.

6. The source driver according to claim 5, which repeats:
setting the output switch so as to drive one data line with the high-side amplifier and to drive the other data line with the low-side amplifier;
bringing the output switch to an off-state and turning the charge share switch on;
setting the output switch so as to drive the other data line with the high-side amplifier and to drive the one data line with the low-side amplifier; and
bringing the output switch to an off-state and turning the charge share switch on.

7. A liquid crystal display device comprising:
a liquid crystal panel;
a source driver according to claim 1 which drives a plurality of data lines of the liquid crystal panel; and
a gate driver circuit which drives a plurality of scanning lines of the liquid crystal panel.
